(19) United States
(12) Patent Application Publication
(10) Pub. No.: US 2003/0177189 A1
(43) Pub. Date: Sep. 18, 2003

(54) E-mail control method, E-mail control apparatus, and computer product

(75) Inventor: Ryuji Tomono, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/277,741

(22) Filed: Oct. 23, 2002

(30) Foreign Application Priority Data
Mar. 18, 2002 (JP) 2002-074308

(51) Int. Cl. G06F 15/16

(52) U.S. Cl. 709/206

(57) ABSTRACT

A sender sends a request for sending an E-mail to a receiver. The request includes E-mail addresses of the sender and the receiver. The request also includes a dummy E-mail address of the sender. When the E-mail is sent to the receiver, the E-mail address of the sender is replaced with the dummy E-mail address. The dummy E-mail address is discarded after, for example, one month. As a result, the receiver can send reply mails to the sender for only one month because the receiver does not know the true E-mail address of the sender.

### BACKGROUND OF THE INVENTION

1) Field of the Invention

The present invention relates to a technology that does not include the sender's E-mail address in an E-mail.

2) Description of the Related Art

In the conventional technology, when an electronic mail (E-mail) is sent from a sender to a receiver, the receiver knows the E-mail address of the sender because the E-mail address is included in the E-mail. Two problems arise in this method of sending the E-mails.

First, even if the sender wants to communicate with the receiver temporarily, for example, only once, since the sender's address is included in the E-mail, there is a possibility that the sender receives unwanted mails from the receiver or from a third party.

Second, the sender cannot control the number of replies from the receiver. As a result, the sender may receive unwanted replies from the receiver semi-permanently.

### SUMMARY OF THE INVENTION

It is an object of the present invention to provide a technology that does not include the sender's E-mail address in an E-mail. It is another object of the present invention to provide a technology that limits the number of replies from a receiver of an E-mail.

According to one aspect of the present invention, a sender sends an E-mail to a receiver. The E-mail includes at least a mail text, an E-mail address of the sender, an E-mail address of the receiver, and specific conversion condition. The E-mail from the sender is received. It is judged whether the received E-mail includes the conversion condition. When the E-mail includes the conversion condition, the conversion condition is removed from the E-mail and stored. The E-mail is sent to the receiver based on the conversion condition.

According to another aspect of the present invention, a sender sends an E-mail to a receiver. The E-mail including at least a mail text, an E-mail address of the sender, and an E-mail address of the receiver. Specific conversion condition is stored in correlation with a plurality of E-mail addresses. The E-mail from the sender is received. It is judged whether conversion condition have been stored in correlation with the E-mail address of the sender or the E-mail address of the receiver includes in the received E-mail. If the conversion condition have been stored in correlation with the E-mail address of the sender or the E-mail address of the receiver, the E-mail is sent to the receiver based on the conversion condition.

The conversion condition might be a dummy address of the sender, a time duration for which a reply from the receiver is received, or an allowable number of replies from the receiver.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram of the system configuration of an embodiment of the present invention,

FIG. 2 is a flowchart of a conversion condition registration program in the embodiment,

FIG. 3 is a flowchart of a mail sending program in the embodiment,

FIG. 4 is a flowchart of a conversion processing program in the embodiment,

FIG. 5 is a flowchart of a reply processing program in the embodiment,

FIG. 6 shows an example of a conversion DB in the embodiment, and

FIG. 7 is an example of a display screen on a user terminal in the embodiment.

### DETAILED DESCRIPTIONS

An embodiment of the E-mail control method, E-mail control apparatus, and computer product according to the present invention will now be explained in detail with reference to the accompanying drawings.

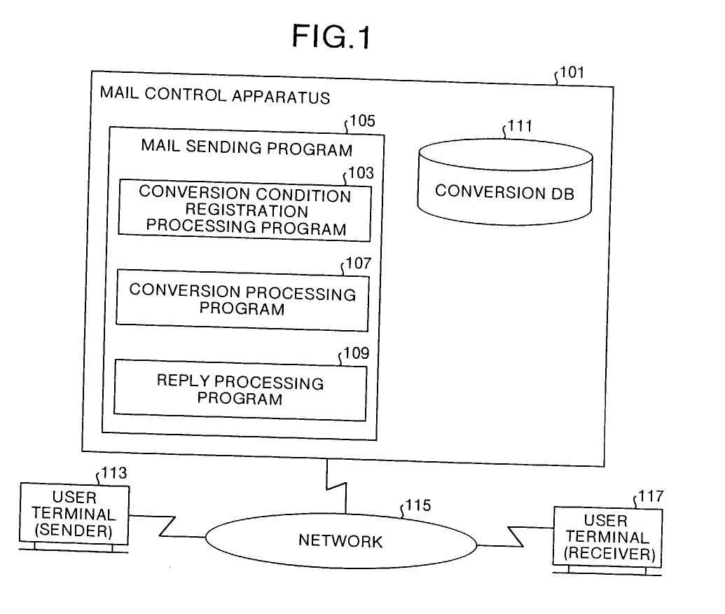

FIG. 1 is a block diagram of the overall system of the present invention. This system includes a mail control apparatus 101, at least one user terminal that functions as mail sender 113, and at least one user terminal that functions as mail receiver 117. The mail control apparatus 101, the mail sender 113, and the mail receiver 117 are connected to each other via a network 115.

The mail control apparatus 101 is, for example, installed in an E-mail control center of the Internet provider. The mail control apparatus 101 comprises a conversion DB 111 that stores sender addresses, converted addresses, expiration dates, allowable number of replies, and total number of replies. The mail control apparatus 101 comprises a memory where mail sending (computer) programs 105 are stored.

The mail sending programs 105 include a conversion condition registration processing program 103 for receiving address conversion conditions from a mail sender and setting it in the conversion DB 111, a conversion processing program 107 for receiving a send mail request from the mail sender and converting a sender address in the send mail request to an optional address based on the conversion DB 111, a reply processing program 109 for receiving a reply mail from a mail receiver and judging whether it is allowed to send the reply mail based on the conversion DB 111.

If an arrangement is made such that the sender can set the conversion conditions in the conversion DB 111 beforehand, then the conversion condition registration processing program 103 may not be provided.

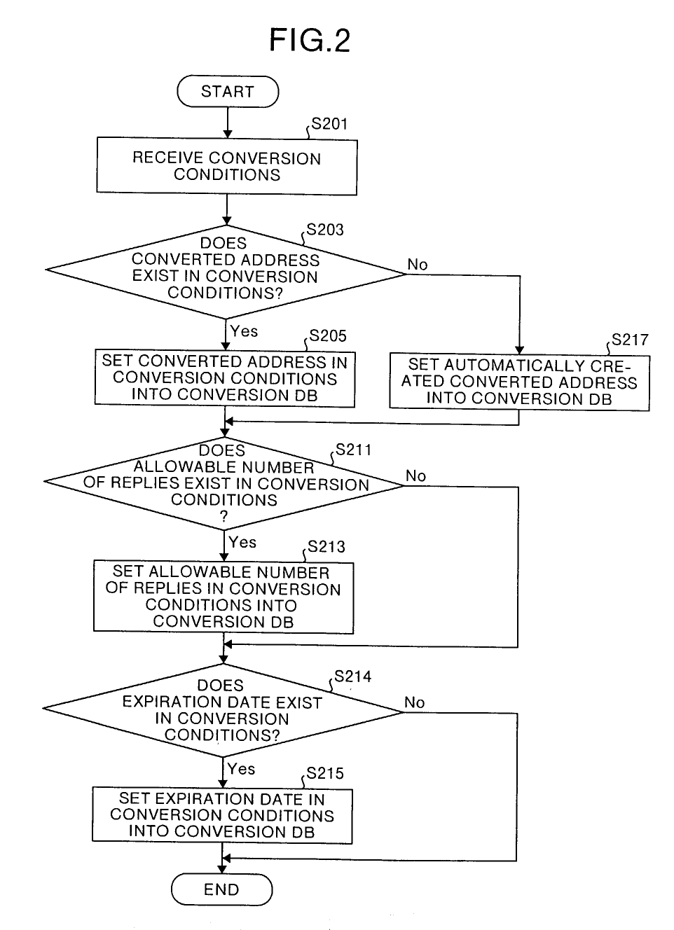

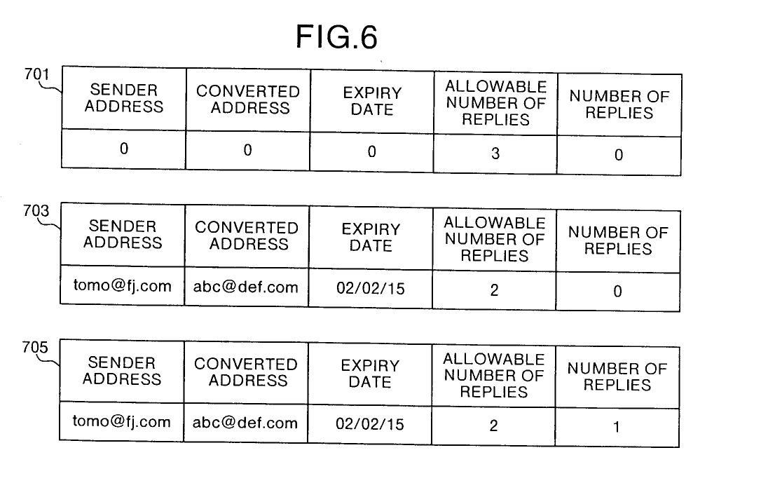

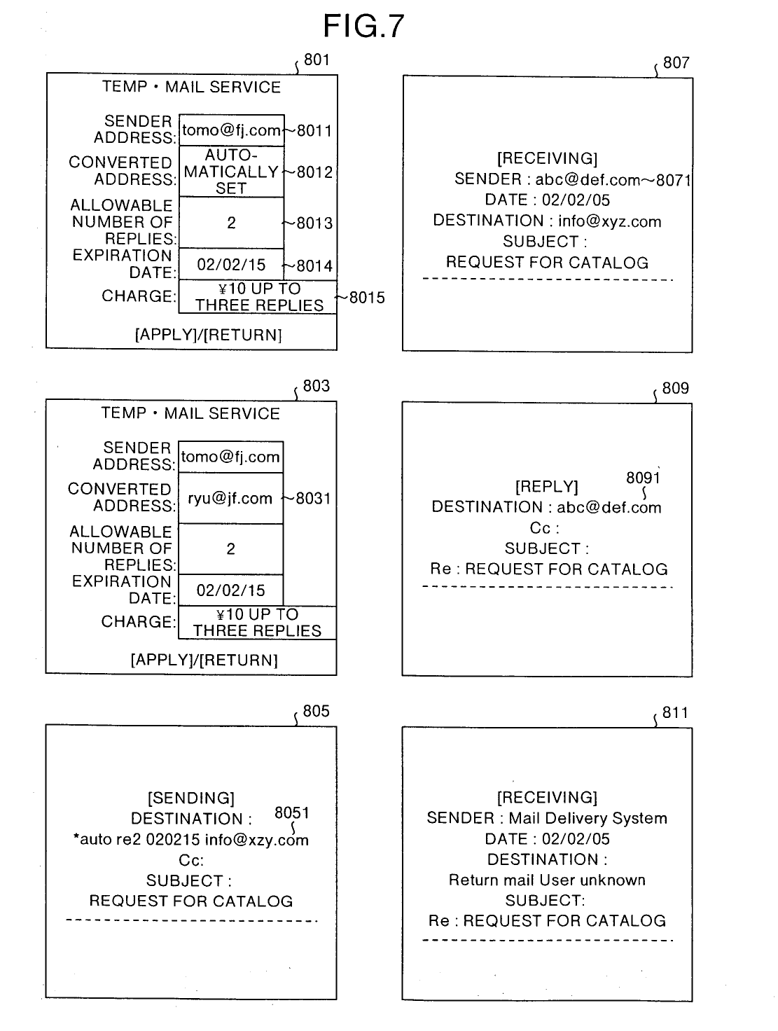

To begin with, processing for receiving the address conversion conditions and the conversion conditions including a mail reply conditions from the sender, and registering these conditions in the conversion DB 111 will be explained, using FIG. 1, FIG. 2, FIG. 6 and FIG. 7.

FIG. 2 is a flowchart which explains the conversion condition registration processing, FIG. 6 is a diagram which shows specific contents of the conversion DB 111, and FIG. 7 shows an example of a display screen of a user terminal (113, 117) which is operated by the mail sender or the mail replier.

A table 701 in FIG. 6 shows the default settings in the conversion DB 111. As the conversion conditions, sender mail address “0”, converted address “0”, expiration date “0”, allowable number of replies “3”, and number of (total) replies “0” are registered.

The operation of this apparatus when a mail sender registers the address conversion conditions and the conversion conditions including the mail reply conditions will be explained, with reference to FIG. 2.

The mail sender uses the user terminal 113, to input the sender address and the conversion conditions including the converted address, expiration date and allowable number of replies with respect to this apparatus.

A screen 801 in FIG. 7 shows an example of a display screen of the user terminal 113, when the mail sender registers a sending mail address “tomo@fj.com” 8011, a converted address “automatic creation” 8012 which is automatically created by the system, the allowable number of replies “2” 8013, the expiration date “02/02/15” 8014, and the charging method “¥10 up to three replies” 8015, as the conversion conditions, by using the user terminal 113. A screen 803 in FIG. 7 shows an example of a display screen of the user terminal 113, when the mail sender registers the converted address “ryu@fj.com” 8031 input by the mail sender in advance to mail control apparatus 101.

The mail control apparatus 101 receives at step S201 (see FIG. 2) the conversion conditions input by the mail sender. The mail control apparatus 101 judges at step S203 whether the converted address exists in the conversion conditions received from the user terminal 113. If the converted address exists in the conversion conditions, at step S205 the converted address is registered in the conversion DB 111. If the converted address does not exist in the conversion conditions, at step S217 the mail control apparatus 101 automatically creates a converted address and registers that address in the conversion DB 111.

At step S211, it is judged whether an allowable number of replies exists in the conversion conditions. If the allowable number of replies exists in the conversion conditions, at step S213 the allowable number of replies is registered in the conversion DB 111. If the allowable number of replies does not exist in the conversion conditions, the system control is passed to a step S214 explained later.

At step S214, it is judged whether an expiration date exists in the conversion conditions. If the expiration date exists in the conversion conditions, at step S215 the expiration date is registered in the conversion DB 111. If the expiration date does not exist in the conversion conditions, the processing is ended.

A table 703 in FIG. 6 shows the contents of the conversion DB 111 after the registration processing shown in FIG. 2 ends. Table 703 shows that, “tomo@fj.com” is registered as the sender address, automatically created address “abc@ff.com” is registered as the converted address, “02/02/15” is registered as the expiration date, “2” is registered as the allowable number of replies, and “0” is registered as the number of replies.

The processing in which it is a case of performing either one of the conversion condition registration processing, the conversion processing or the reply processing when a send mail request is received from a mail sender, based on the conversion conditions, the destination address or the sender address in the send mail request and the conversion DB 111 will be explained, with reference to FIG. 1 to FIG. 7.

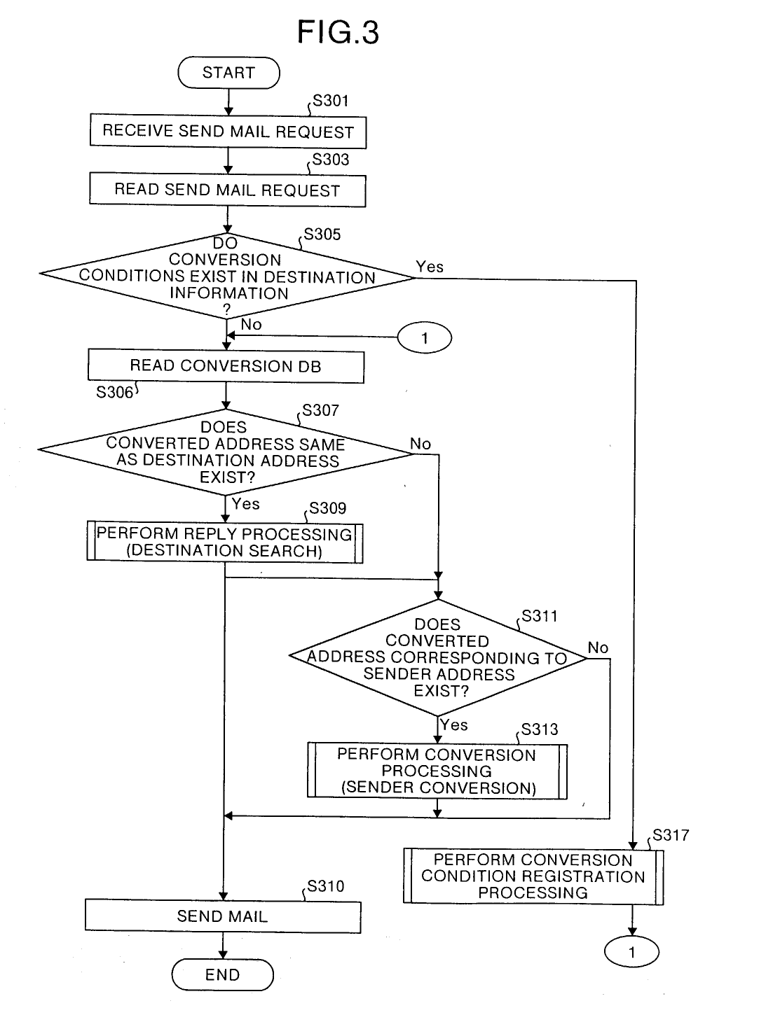

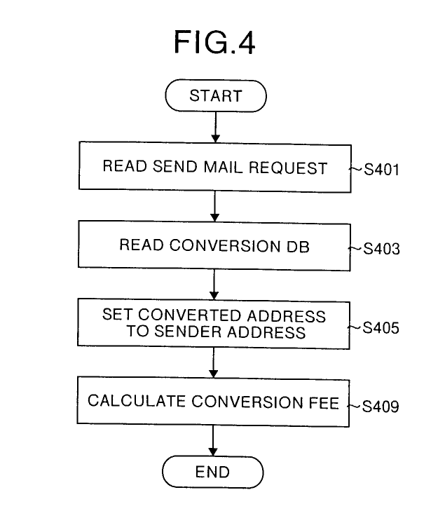

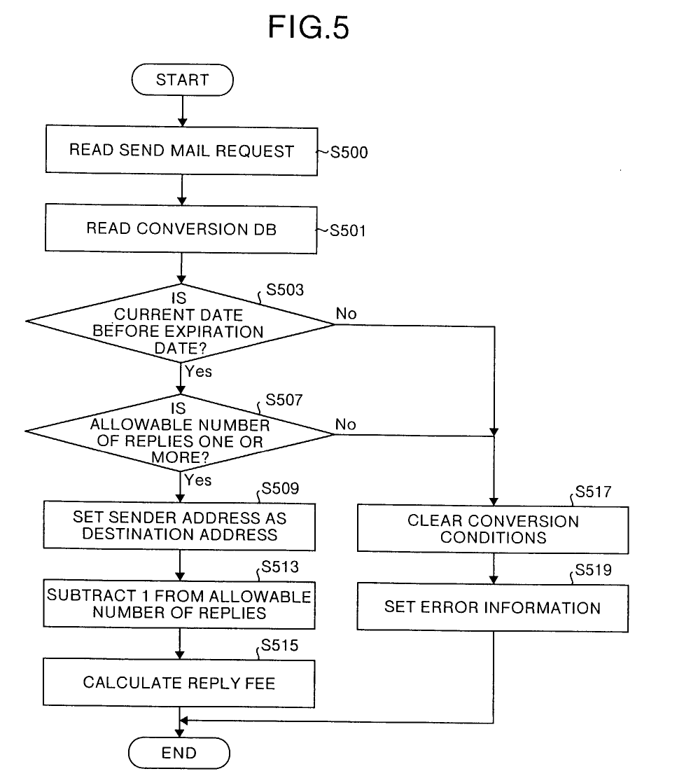

FIG. 3 is a flowchart which explains the mail sending processing including the conversion condition registration processing, the conversion processing and the reply processing. FIG. 4 is a flowchart which explains the conversion processing, and FIG. 5 is a flowchart which explains the reply processing.

The operation of the apparatus when the mail sending processing including the conversion condition registration processing, the conversion processing and the reply processing is to be performed will be explained, with reference to FIG. 3.

The mail sender uses the user terminal 113, to make a send mail request including a sender address and a destination address to the apparatus. The send mail request may include a converted address, an expiration date and the allowable number of replies.

A screen 805 in FIG. 7 shows an example of a display screen of the user terminal 113, when the mail sender uses the user terminal 113 to set “*” which means start of conversion conditions, “auto” which means “automatic creation” of a converted address, “re12” which means “the allowable number of replies”, and “020215” which means the expiration date, before the destination address “info@xyz.com”, and to make a send mail request.

The mail control apparatus 101 receives the send mail request at step S301, and reads the send mail request at step S303.

At step S305, it is judged whether the conversion conditions exist in the send mail request. As a result of judgment, if the conversion conditions exist, at step S317, the conversion condition registration processing is performed, and thereafter at step S306, the conversion DB is to be read. S317 is the same processing as the conversion condition registration processing shown in FIG. 2. As a result of judgment, if the conversion conditions do not exist, at step S306, the conversion DB 111 is read, and at step S307, it is judged whether the address same as the destination address in the send mail request exists in the converted addresses in the conversion DB 111. As a result of judgment, if the converted address same as the destination address exists, at step S309, the reply processing is performed, and at step S310, the sending processing of the send mail request is performed.

As a result of judgment, if the converted address same as the destination address does not exist, at step S311, it is judged whether an address same as the sender address in the send mail request exists in the converted addresses in the conversion DB 111. As a result of judgment, if the converted address exists, at step S313, the conversion processing is performed. As a result of judgment, if the converted address does not exist, at step S310, the sending processing of the send mail request is performed.

The operation of the apparatus when the send mail request from a mail sender is received, and the sender address in the send mail request is converted to an optional address based on the conversion DB 111, to send the mail, will be explained with reference to FIG. 4.

The mail control apparatus 101 reads the send mail request at step S401, and reads the conversion DB 111 at step S403. At step S405, the apparatus sets the converted address in the conversion DB 111, corresponding to the sender address in the send mail request, to the sender address in the send mail request, and calculates the accounting fee based on the converted address setting processing at step S409.

Reference numeral 8071 in a screen 807 in FIG. 7 shows an example of a display screen of a user terminal 117, when a mail receiver receives a mail in which “abc@def.com”, being a converted address automatically created by the apparatus, is set as the sender address, instead of the original sender address, “tomo@fj.com”.

The operation of the apparatus, when the apparatus receives a send (reply) mail request from the mail receiver, and performs the reply processing by judging whether the sending (reply) of the send (reply) mail request is to be approved or not based on the conversion DB 111 will be explained with reference to FIG. 5.

The mail control apparatus 101 reads the send mail request at step S500, and reads the conversion DB 111 at step S501.

At step S503, it is judged whether the current date information controlled by the apparatus is before the expiration date in the conversion DB 111. As a result of judgment, if the current date information is before the expiration date, at step S507, it is judged whether the allowable number of replies is one or more. As a result of judgment, if the current date information is not before the expiration date, at step S517, the converted address in the conversion DB 111 corresponding to the sender address in the send mail request is deleted, and at step S519, error information is set with respect to the send (reply) mail request. 809 in FIG. 7 shows an example of a display screen of the user terminal 117, when the mail replier recognizes “abc@def.com” as the original sender address, and sends (replies) a mail.

A screen 811 in FIG. 7 shows an example of a display screen of the user terminal 117, when the mail receiver recognizes “abc@def.com” as the original sender address, and has sent (replied) a mail, but since the expiration date or the allowable number of replies is exceeded, a mail with a title indicating a dead letter is sent to the mail receiver.

As a result of judgment at step S507, when the allowable number of replies is one or more, at step S509, a sender address corresponding to the converted address in the conversion DB 111, which is the same as the destination address, is set to the destination address in the send (reply) mail request. Thereafter, at step S513, the allowable number of replies in the conversion DB 111 is subtracted, and at step S515, calculation of the accounting fee is carried out based on the converted address setting processing.

A table 705 in FIG. 6 shows the contents of the conversion DB 111, when the reply processing is carried out based on the conversion conditions by mail control apparatus 101.

As the conversion conditions, there are registered in the DB 111 the sending mail address “tomo@fj.com”, the converted address, “abc@ff.com” automatically created by the apparatus, the expiration date “02/02/15”, the allowable number of replies “1” and the number of replies “1”.

When the allowable number of replies is not one or more, at step S517, the converted address in the conversion DB 111, corresponding to the sender address in the send mail request is deleted, and at step S519, error information is set, which is to be sent to the E-mail control server, which controls the sender address in the send (reply) mail request.

As explained above, according to the present invention, an E-mail from the sender is sent to the receiver based on the conversion conditions. The sender may set the conversion condition or default conversion condition may be used. When the sender sets the conversion condition he/she can include the conversion conditions in the E-mail. When the default conversion condition is used, the default conversion condition is stored in a memory beforehand.

The conversion condition includes a dummy E-mail address of the sender. This dummy address is included in the E-mail and the E-mail is sent to the receiver. As a result, the receiver will not know the true E-mail address of the sender.

The conversion condition includes a time duration for which a reply from the receiver is received. A reply E-mail from the receiver coming after this time duration is not transmitted to the sender. If the time duration is, for example, one month, then the receiver can send reply E-mails to the sender for only one month.

The conversion condition includes an allowable number of replies from the receiver. If a total number of reply E-mails from the receiver to the sender exceeds this allowable number then a reply E-mail from the receiver is not transmitted to the sender. If the allowable number of replies is, for example, three, then fourth reply mail from the receiver will not be transmitted to the sender.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An E-mail control method comprising:
a sender sending an E-mail to a receiver, the E-mail including at least a mail text, an E-mail address of the sender, an E-mail address of the receiver, and specific conversion condition;
receiving the E-mail from the sender;
judging whether the received E-mail includes the conversion condition;
when it is judged that the E-mail includes the conversion condition, removing the conversion condition from the E-mail and storing the conversion condition, and sending the E-mail to the receiver based on the conversion condition.

2. The E-mail control method according to claim 1, wherein the conversion condition includes a dummy E-mail address of the sender, wherein the E-mail address of the sender in the E-mail is changed to the dummy E-mail address when sending the E-mail to the receiver.

3. The E-mail control method according to claim 1, wherein the conversion condition includes a time duration for which a reply from the receiver is received, wherein if a reply E-mail is received from the receiver and the date of reception of the reply E-mail is not within the time duration, the reply E-mail is not transmitted to the E-mail address of the sender.

4. The E-mail control method according to claim 1, wherein the conversion condition include an allowable number of replies from the receiver, wherein a total number of reply E-mails from the receiver to the sender is counted and if the total number of reply E-mails exceed the allowable number of replies then reply E-mail thereafter is not transmitted to the E-mail address of the sender.

5. An E-mail control method comprising:
a sender sending an E-mail to a receiver, the E-mail including at least a mail text, an E-mail address of the sender, and an E-mail address of the receiver;
storing specific conversion condition in correlation with a plurality of E-mail addresses;
receiving the E-mail from the sender and judging whether conversion condition have been stored in correlation with the E-mail address of the sender or the E-mail address of the receiver includes in the received E-mail;
when it is judged that the conversion condition have been stored in correlation with the E-mail address of the sender or when it is judged that the conversion condition have been stored in correlation with the E-mail address of the receiver, sending the E-mail to the receiver based on the conversion condition.

6. The E-mail control method according to claim 5, wherein the conversion condition includes a dummy E-mail address of the sender, wherein the E-mail address of the sender in the E-mail is changed to the dummy E-mail address when sending the E-mail to the receiver.

7. The E-mail control method according to claim 5, wherein the conversion condition includes a time duration for which a reply from the receiver is received, wherein if a reply E-mail is received from the receiver and the date of reception of the reply E-mail is not within the time duration, the reply E-mail is not transmitted to the E-mail address of the sender.

8. The E-mail control method according to claim 5, wherein the conversion condition include an allowable number of replies from the receiver, wherein a total number of reply E-mails from the receiver to the sender is counted and if the total number of reply E-mails exceed the allowable number of replies then reply E-mail thereafter is not transmitted to the E-mail address of the sender.

9. An E-mail control apparatus comprising:
a receiving unit that receives an E-mail from a sender to be sent to a receiver, the E-mail including at least a mail text, an E-mail address of the sender, an E-mail address of the receiver, and specific conversion condition;
a judging unit that judges whether the received E-mail includes the conversion condition;
a sending unit that, when the judging unit has judged that the E-mail includes the conversion condition, removes the conversion condition from the E-mail, stores the conversion condition, and sends the E-mail to the receiver based on the conversion condition.

10. The E-mail control apparatus according to claim 9, wherein the conversion condition includes a dummy E-mail address of the sender, wherein the sending unit changes the E-mail address of the sender in the E-mail to the dummy E-mail address when sending the E-mail to the receiver.

11. The E-mail control apparatus according to claim 9, wherein the conversion condition includes a time duration for which a reply from the receiver is received,
the E-mail control apparatus further comprising a reply judgement unit that judges, if a reply E-mail is received from the receiver, whether the date of reception of the reply E-mail is within the time duration, and judges not to transmit the reply E-mail to the E-mail address of the sender if the date of reception of the reply E-mail is not within the time duration.

12. The E-mail control apparatus according to claim 9, wherein the conversion condition include an allowable number of replies from the receiver,
the E-mail control apparatus further comprising a reply judgement unit that counts a total number of reply E-mails from the receiver to the sender, and judges not to transmit the reply E-mail thereafter to the E-mail address of the sender if the total number of reply E-mails exceed the allowable number of replies.

13. An E-mail control apparatus comprising:
a receiving unit that receives an E-mail from a sender to be sent to a receiver, the E-mail including at least a mail text, an E-mail address of the sender, and an E-mail address of the receiver;
a storing unit that stores specific conversion condition in correlation with a plurality of E-mail addresses;
a judging unit that judges whether conversion condition have been stored in correlation with the E-mail address of the sender or the E-mail address of the receiver includes in the received E-mail;
a sending unit that, when the judging unit has judged that the conversion condition have been stored in the memory unit in correlation with the E-mail address of the sender or the E-mail address of the receiver, sends the E-mail to the receiver based on the conversion condition.

14. The E-mail control apparatus according to claim 13, wherein the conversion condition includes a dummy E-mail address of the sender, wherein the sending unit changes the E-mail address of the sender in the E-mail to the dummy E-mail address when sending the E-mail to the receiver.

15. The E-mail control apparatus according to claim 13, wherein the conversion condition includes a time duration for which a reply from the receiver is received,
the E-mail control apparatus further comprising a reply judgement unit that judges, if a reply E-mail is received from the receiver, whether the date of reception of the reply E-mail is within the time duration, and judges not to transmit the reply E-mail to the E-mail address of the sender if the date of reception of the reply E-mail is not within the time duration.

16. The E-mail control apparatus according to claim 13, wherein the conversion condition include an allowable number of replies from the receiver,
the E-mail control apparatus further comprising a reply judgement unit that counts a total number of reply E-mails from the receiver to the sender, and judges not to transmit the reply E-mail thereafter to the E-mail address of the sender if the total number of reply E-mails exceed the allowable number of replies.

17. A computer readable recording medium that stores a computer program which allows a computer to execute an E-mail control method, the E-mail control method comprising:
a sender sending an E-mail to a receiver, the E-mail including at least a mail text, an E-mail address of the sender, an E-mail address of the receiver, and specific conversion condition;
receiving the E-mail from the sender;
judging whether the received E-mail includes the conversion condition;
when it is judged that the E-mail includes the conversion condition, removing the conversion condition from the E-mail and storing the conversion condition, and sending the E-mail to the receiver based on the conversion condition.

18. The E-mail control method according to claim 17, wherein the conversion condition includes a dummy E-mail address of the sender, wherein the E-mail address of the sender in the E-mail is changed to the dummy E-mail address when sending the E-mail to the receiver.

19. The E-mail control method according to claim 17, wherein the conversion condition includes a time duration for which a reply from the receiver is received, wherein if a reply E-mail is received from the receiver and the date of reception of the reply E-mail is not within the time duration, the reply E-mail is not transmitted to the E-mail address of the sender.

20. The E-mail control method according to claim 17, wherein the conversion condition include an allowable number of replies from the receiver, wherein a total number of reply E-mails from the receiver to the sender is counted and if the total number of reply E-mails exceed the allowable number of replies then reply E-mail thereafter is not transmitted to the E-mail address of the sender.

21. A computer readable recording medium that stores a computer program which allows a computer to execute an E-mail control method, the E-mail control method comprising:
a sender sending an E-mail to a receiver, the E-mail including at least a mail text, an E-mail address of the sender, and an E-mail address of the receiver;
storing specific conversion condition in correlation with a plurality of E-mail addresses;
receiving the E-mail from the sender and judging whether conversion condition have been stored in correlation with the E-mail address of the sender or the E-mail address of the receiver includes in the received E-mail;
when it is judged that the conversion condition have been stored in correlation with the E-mail address of the sender or when it is judged that the conversion condition have been stored in correlation with the E-mail address of the receiver, sending the E-mail to the receiver based on the conversion condition.

22. The E-mail control method according to claim 21, wherein the conversion condition includes a dummy E-mail address of the sender, wherein the E-mail address of the sender in the E-mail is changed to the dummy E-mail address when sending the E-mail to the receiver.

23. The E-mail control method according to claim 21, wherein the conversion condition includes a time duration for which a reply from the receiver is received, wherein if a reply E-mail is received from the receiver and the date of reception of the reply E-mail is not within the time duration, the reply E-mail is not transmitted to the E-mail address of the sender.

24. The E-mail control method according to claim 21, wherein the conversion condition include an allowable number of replies from the receiver, wherein a total number of reply E-mails from the receiver to the sender is counted and if the total number of reply E-mails exceed the allowable number of replies then reply E-mail thereafter is not transmitted to the E-mail address of the sender.
